(19) United States
(12) Patent Application Publication
(10) Pub. No.: US 2005/0237166 A1
(43) Pub. Date: Oct. 27, 2005

(54) Vehicle anti-thief device with bluetooth recognition

(75) Inventor: Shin-Chung Chen, Luchu (TW)

Correspondence Address: BACON & THOMAS, PLLC, 625 SLATERS LANE, FOURTH FLOOR, ALEXANDRIA, VA, 22314, US

(73) Assignee: Tung Thih Enterprise Co., Ltd., Luchu (TW)

(21) Appl. No.: 10/867,715

(22) Filed: Jun. 16, 2004

(30) Foreign Application Priority Data
Mar. 31, 2004 (TW) 93204923

(51) Int. Cl. B60R 25/10

(52) U.S. Cl. 340/426.13; 455/99

(57) ABSTRACT

A vehicle anti-thief device includes an on-vehicle main unit, an on-vehicle bluetooth module, and a bluetooth mobile terminal to be carried by the user. When the user leaved the car, the on-vehicle bluetooth module receives no signal from the bluetooth mobile terminal and then drives the on-vehicle main unit into alarm mode. When the user with the bluetooth mobile terminal entered the communication radius of the bluetooth module, the bluetooth mobile terminal connects the on-vehicle bluetooth module wirelessly and gives a disarm signal to disarm alarm setting of the on-vehicle main unit.

### BACKGROUND OF THE INVENTION

1. Field of the Invention

The present invention relates to a vehicle anti-thief device and more particularly, to such a vehicle anti-thief device that uses a bluetooth recognition system to automatically control arming/disarming of alarm setting.

2. Description of Related Art

In order to prevent stealing of the car by a thief or occurrence of an accident, the owner of the car may install an anti-thief device in the car. When leaving the car, the owner of the car can initiate the anti-thief device, driving different sensors to detect different abnormal conditions.

When an abnormal condition of the car occurred, for example, an intruder intruded the car, the corresponding sensor is induced to trigger the anti-thief device. Conventional vehicle anti-thief device commonly use a siren to give a sharp sound to threaten the intruder. When heard the sharp sound of the siren, the owner of the car can rapidly come to the place of the car to examine what happened.

However, the sharp sound of the siren of a motor vehicle anti-thief device is hearable within a limited distance. The owner of the motor vehicle may not be able to hear the sharp sound of the siren of the motor vehicle during the occurrence of an abnormality of the motor vehicle. In this case, the owner of the motor vehicle cannot take the necessary step in time. Further, when the motor vehicle is being removed by a wrecker, the owner of the motor vehicle cannot know what is happening if he or she does not hear the sound of the alarm of the anti-thief device of the motor vehicle. In this case, the owner of the motor vehicle knows that the motor vehicle has been taken away only when returns to the parking place. The aforesaid conditions happened just because the motor vehicle anti-thief device is unable to actively inform the owner of the motor vehicle. In general, a conventional motor vehicle anti-thief device cannot well protect the motor vehicle or actively inform the owner of the motor vehicle of the occurrence of an abnormality of the motor vehicle. Further, the sharp sound of the alarm causes a noise problem to the surroundings.

Therefore, it is desirable to provide a vehicle anti-thief device that eliminates the aforesaid drawbacks.

### SUMMARY OF THE INVENTION

The present invention has been accomplished under the circumstances in view. It is therefore the main object of the present invention to provide a vehicle anti-thief device, which automatically detects the presence of a bluetooth mobile terminal and automatically recognize the code of the detected bluetooth mobile terminal, and automatically disarm alarm setting upon recognition of the code of the detected bluetooth mobile terminal. It is another object of the present invention to provide a vehicle anti-thief device, which automatically informs the owner of the motor vehicle upon detection of an abnormality of the motor vehicle.

To achieve these and other objects of the present invention, the vehicle anti-thief device comprises an on-vehicle main unit, at least one sensor, an alarm signal output means, an on-vehicle bluetooth module, and a bluetooth mobile terminal. The on-vehicle main unit is installed in a car. The at least one sensor is mounted in at least one corresponding location of the car on-vehicle main unit and electrically connected to the on-vehicle main unit, and adapted to detect an abnormality of the respective corresponding location of said car and to send a corresponding abnormality signal to the on-vehicle main unit. The alarm signal output means can be, for example, a siren mounted in the car on-vehicle main unit and electrically connected to the on-vehicle main unit, and controlled to output a corresponding alarm upon the on-vehicle main unit in receipt of the corresponding abnormality signal from one the sensor on-vehicle main unit. The on-vehicle bluetooth module is mounted in the car in which the on-vehicle main unit is installed and electrically connected to the on-vehicle main unit, and adapted to actively detect the presence of an external bluetooth module within the communication radius thereof and to make a code recognition with the detected external bluetooth module and then to communicate with the external bluetooth module after success of the code recognition, the communication radius of the on-vehicle bluetooth module extending to an external geo-zone from the body of the car The bluetooth mobile terminal is adapted to actively detect the presence of a bluetooth module within the communication radius thereof, and to make a code recognition with the detected external bluetooth module, and then to communicate with the detected bluetooth module after success of the code recognition. When the bluetooth mobile terminal anti-thief device is connected to the on-vehicle bluetooth module after success of a code recognition, the on-vehicle bluetooth module anti-thief device sends a disarm signal to the on-vehicle main unit to disable the alarm setting of the on-vehicle main unit.

### BRIEF DESCRIPTION OF THE DRAWINGS

FIG. 1 is a schematic drawing showing an operation environment according to the present invention.

FIG. 2 is a system block diagram of the present invention.

FIG. 3 is a schematic drawing showing the positioning of the in-car recognition button of the on-vehicle main unit in the car according to the present invention.

### DETAILED DESCRIPTION OF THE PREFERRED EMBODIMENT

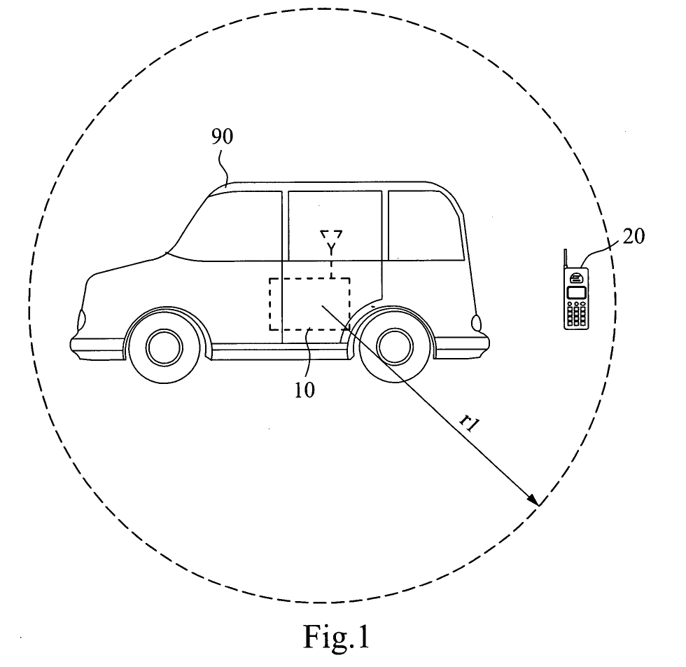

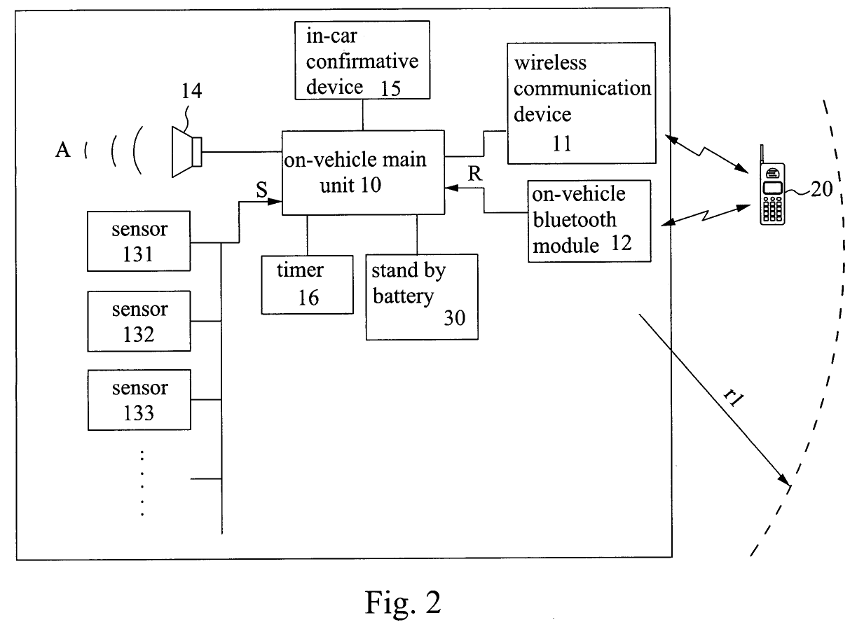

Referring to FIG. 1 and 2, a vehicle anti-thief device in accordance with the present invention is shown comprising an on-vehicle main unit 10 installed in a car 90, an on-vehicle bluetooth module 12 installed in the car 90 and electrically connected to the on-vehicle main unit 10, and a bluetooth mobile terminal 20.

The on-vehicle main unit 10 is electrically connected to a plurality of sensors 131, 132, 133 and a siren 14 in the car 90. The sensors 131, 132, 133 can be car door sensors, keyway sensors, trunk lid sensors and or any of a variety of vehicle burglar alarm sensors.

When an abnormal condition at one particular location in the car 90 occurred, for example, when the car door of the car 90 is opened abnormally or an external body is inserted into the keyway (car door switch or ignition switch) after the on-vehicle main unit 10 has been armed up, the respective sensor sends an abnormality signal S to the on-vehicle main unit 10, causing the on-vehicle main unit 10 to output an audio alarm signal through the siren 14, informing the owner of the car 90 of the occurrence of an abnormal condition. At the same time, the on-vehicle main unit 10 outputs a signal to a wireless communication device 11, thereby causing the wireless communication device 11 to send an alarm signal to a communication address assigned by the owner of the car 90. The aforesaid wireless communication device 11 can be a GPRS mobile telephone, GSM, PDA, and on-vehicle bluetooth module 12,. The alarm signal can be a short message, pre-recorded chunk, fax message, or e-mail message. The communication address can be, for example, the telephone number of the aforesaid bluetooth mobile terminal 20, the telephone number of the car owner's house, the telephone number or fax number of the car owner's office, or an e-mail address.

When a bluetooth mobile terminal 20 approaching the car 90, the on-vehicle bluetooth module 12 detects the presence of the bluetooth terminal in the communication radius rl and compares the built-in recognition code to the code of the bluetooth terminal 20 been detected within the communication radius rl. When matched, the on-vehicle bluetooth module 12 accepts connection from the bluetooth mobile terminal 20 and receives a disarm signal R from the bluetooth mobile terminal 20 to disarm alarm setting of the on-vehicle main unit 10. The communication radius rl of the on-vehicle bluetooth module 12 reaches an area outside the car 90. The aforesaid bluetooth mobile terminal 20 is a bluetooth mobile phone. When disarming alarm setting of the on-vehicle main unit 10 upon receipt of the disarm signal R from the bluetooth mobile terminal 20, the on-vehicle bluetooth module 12 simultaneously disarm the locking setting of the center lock of the car 90.

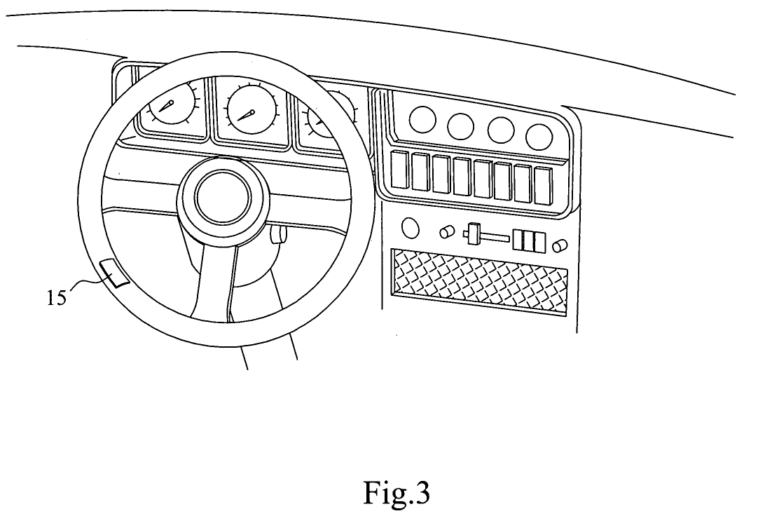

Referring to FIG. 3, the aforesaid on-vehicle main unit 10 further comprises an in-car confirmative device 15 and a timer 16. Through the in-car confirmative device 15 the user can input a recognition signal C into the on-vehicle main unit 10 to confirm the alarm setting of the on-vehicle main unit 10 is really to be disabled. The timer 16 is adapted to drive the on-vehicle main unit 10 to re-start alarm setting if the on-vehicle main unit 10 does not receive a confirmative signal C from the in-car confirmative device 15 within a predetermined time interval. The in-car confirmative device 15 according to the present preferred embodiment is a push-button installed in the instrument panel or steering wheel of the car. Alternatively, the in-car recognition device 15 can be a PIN code for input into the on-vehicle main unit 10 through a keyboard, an induction code for IC chip-based electronic key, or the like.

The vehicle anti-thief device further comprises a stand by battery 30 electrically connected to the on-vehicle main unit 20. When the power of the car battery of the car 90 is low, the stand by battery 30 provides the on-vehicle main unit 10 with the necessary working voltage for normal functioning.

Although the present invention has been explained in relation to its preferred embodiment, it is to be understood that many other possible modifications and variations can be made without departing from the spirit and scope of the invention as hereinafter claimed.

1. A vehicle anti-thief device comprising:
an on-vehicle main unit installed in a car;
at least one sensor mounted in at least one corresponding location of the car on-vehicle main unit and electrically connected to said on-vehicle main unit and adapted to detect an abnormality of the respective corresponding location of said car and to send a corresponding abnormality signal to said on-vehicle main unit;
at least one alarm device mounted in the car on-vehicle main unit and electrically connected to said on-vehicle main unit and controlled to output a corresponding alarm upon said on-vehicle main unit in receipt of said corresponding abnormality signal from one said sensor on-vehicle main unit;
an on-vehicle bluetooth module mounted in the car on-vehicle main unit and electrically connected to said on-vehicle main unit and adapted to actively detect the presence of an external bluetooth module within the communication radius thereof and to make a code recognition with the detected external bluetooth module and then to communicate with said external bluetooth module after success of said code recognition, the communication radius of said on-vehicle bluetooth module extending to an external geo-zone from the body of said car;
a bluetooth mobile terminal adapted to actively detect the presence of a bluetooth module within the communication radius thereof and to make a code recognition with the detected external bluetooth module and then to communicate with the detected bluetooth module after success of said code recognition;
wherein when the bluetooth mobile terminal anti-thief is connected to said on-vehicle bluetooth module after success of a code recognition, the on-vehicle bluetooth module anti-thief sends a disarm signal to said on-vehicle main unit to disable the alarm setting of said on-vehicle main unit.

2. The vehicle anti-thief device as claimed in claim 1, further comprising an in-car device for enabling the user to input a confirmative signal into said on-vehicle main unit to confirm the alarm setting of said on-vehicle main unit is really desired to be disabled, and a timer adapted to drive said on-vehicle main unit to re-start alarm setting when said on-vehicle main unit receives no confirmative signal from said in-car confirmative device within a predetermined time interval.

3. The vehicle anti-thief device as claimed in claim 2, wherein said in-car confirmative device is a push-button mounted inside the car in which said on-vehicle main unit is installed.

4. The vehicle anti-thief device as claimed in claim 1, wherein said bluetooth mobile terminal is a bluetooth mobile phone.

5. The vehicle anti-thief device as claimed in claim 1, wherein said at least one alarm device comprises a siren.

6. The vehicle anti-thief device as claimed in claim 1, wherein said at least one alarm device comprises a wireless communication device connectable to a communication address assigned by the user of said car wirelessly.

7. The vehicle anti-thief device as claimed in claim 6, wherein said wireless communication device is a GPRS mobile telephone.

8. The vehicle anti-thief device as claimed in claim 6, wherein said communication address is a mobile telephone number.

9. The vehicle anti-thief device as claimed in claim 6, wherein said alarm is a short message.

10. The vehicle anti-thief device as claimed in claim 1, wherein said on-vehicle main unit unlocks the central door lock of the car upon receiving said disarm signal.
